(19) United States
(12) Patent Application Publication
(10) Pub. No.: US 2026/0157404 A1
(43) Pub. Date: Jun. 11, 2026

(54) System and Method for Extracting and Packaging Coconut Water

(71) Applicant: Justin ANDREWS, Chelmford, MA (US)

(72) Inventor: Justin ANDREWS, Chelmford, MA (US)

(21) Appl. No.: 18/973,618

(22) Filed: Dec. 9, 2024

(51) Int. Cl. A23L 2/74; B01D 61/14

(52) U.S. Cl. CPC A23L 2/74; B01D 61/145; B01D 61/147; B01D 61/149

(57) ABSTRACT

The present invention discloses an aseptic system and method for the aseptic and sterile packaging of fresh coconut water, preserving its freshness, flavor, aroma, and nutritional content. The invention encompasses an innovative process involving aseptic extraction, filtration, and cooling, ensuring the production of sterile coconut water that maintains its qualities for an extended period.

### FIELD OF INVENTION

The present invention relates to a system and method for extracting and packaging a natural raw coconut water. More specifically, the present invention relates to a system of aseptic extraction and sterile packaging of fresh coconut water to preserve the freshness, flavor, aroma, and nutrients of the natural raw coconut water.

### BACKGROUND OF THE INVENTION

In traditional manufacturing practices, both low and high thermal pasteurization methods have conventionally been employed for the processing and packaging of fresh coconut water. However, these approaches have significant drawbacks as they compromise the freshness, flavor, aroma, and nutritional integrity of coconut water. Consequently, there exists a necessity for an innovative system and method that enables the aseptic and sterile packaging of coconut water, ensuring the preservation of its freshness, flavor, aroma, and nutritional content, akin to the experience of consuming coconut water directly from the fruit. While certain low-temperature thermal pasteurization techniques have been explored for coconut water processing, these methods still fall short in retaining the desired freshness and flavor, and they may even introduce alterations to the aroma of the coconut water.

A US Patent U.S. Pat. No. 9,968,122 assigned to Harmless Harvest Inc. discloses a method of preparing coconut water that removes C. botulinum spores and retains the flavor of natural unprocessed coconut water. The method comprises heating coconut water to a temperature of about 63° C. to about 73° C. for about 1 to 2 minutes while filtering through two micro filters in series having a pore size of about 0.2 microns to remove C. botulinum spores and retain coconut water flavor. Although, the patent includes a method for preparing sterile coconut water, it employs a heating process that adversely impacts the natural aroma and nutrition of fresh young coconut water. These issues collectively contribute to an outcome that is less desirable for the end consumer, who anticipates a natural and raw coconut water experience.

A research article titled “Coconut water processing using ultrafiltration and pasteurization,” assigned to Rio de Janeiro, discloses a method of processing fresh coconut water immediately after extraction and cooling it down to 15° C. Ultra-filtration is conducted in a plate and frame unit comprising 20 kDa membranes. The Process is carried out at 5 bar and 15° C. Although, the fresh coconut water is processed at cold temperature and filtered at low pressure and temperature. However, the disclosed method is inefficient for processing fresh coconut water in a cold environment. However, 4° C. or below is efficient and retains coconut water's color, aroma, and freshness.

Another U.S. Pat. No. 10,499,666 assigned to Nilang Patel describes an oxygen free coconut water processing and packaging method establishing an inert transfer environment by injecting an inert gas substantially throughout the oxygen free coconut water processing and packaging pathway. The method then modifies an atmospheric condition within the coconut by providing the inert gas at a desired atmospheric pressure to engender flow of the coconut water through an egress port. The coconut water is then sterilized by way of a cold micro-filter array. The method then circulates the coconut water between a chiller and the oxygen free collection vessel to maintain the coconut water at a predetermined chill temperature until filling. Although, the patent explains the sterilization and packaging of the coconut water in chill environment.

By circumventing the shortcomings of traditional methods, this system and method aims to deliver an unparalleled coconut water product that faithfully captures the essence of natural, fresh, and raw coconut water. Therefore, the present invention is designed to address the peculiar challenges in the prior art; the present invention discloses a ground breaking approach characterized by a 100% cold process that leverages advanced filtering techniques and aseptic methods. The cold processing, coupled with precisely timed extraction and packaging processes, this innovation ensures the processing and packaging of coconut water in a sterile and fresh state.

It is apparent now that numerous methods and systems are developed in the prior art that are adequate for various purposes. Furthermore, even though these inventions are an improvement to the existing methods. Still, to preserve the aroma and taste of the fresh coconut water, we need improvements in the existing methods. Thus, there is a need to provide a system and a method for aseptic and sterile packaging of fresh coconut water to preserve the freshness, flavor, aroma, and nutrients of natural raw coconut water.

### SUMMARY OF THE INVENTION

In accordance with the present invention, the disadvantages and limitations of the prior art are substantially avoided by providing a comprehensive system and method for packaging sterile coconut water while safeguarding its freshness, flavor, aroma, and nutritional content, preserving the natural raw characteristics of coconut water. The system encompasses an aseptic coconut water extraction unit, an aseptic piping system, a filtration system, and an aseptic packaging unit. The method involves aseptic coconut water extraction, followed by cooling to 4 degrees Celsius and filtration through a series of macro and ultra-filters. Subsequently, the coconut water is cooled down to 4 degrees Celsius and aseptically packaged into sterile bottles within one hour of extraction.

The present invention relates to an aseptic system for extracting and packaging coconut water within a specific time period. The aseptic system comprises an aseptic coconut water extraction unit for extracting natural raw coconut water from one or more coconuts to collect extracted coconut water. In more preferred embodiment, the aseptic coconut water extraction unit is a transparent vacuum glass jar that allows visible purity checks and separates impurities from the natural raw coconut water. The natural raw coconut water is extracted with minimal oxygen contact using a piercing needle and collected in the aseptic coconut water extraction unit.

Further, the aseptic system includes a pre-filtration unit for filtering the extracted coconut water through a first micro-filter to produce pre-filtered coconut water. In a preferred embodiment of the present invention, the first micro-filter is a 20-micron filter to remove husks, fibers, and shells of one or more coconuts. Further, the aseptic system includes an aseptic piping unit for cooling the pre-filtered coconut water at 4 degrees Celsius to produce cold pre-filtered coconut water.

Preferably, the aseptic piping unit is a sterile pipe maintained at 4 degrees Celsius to cool and maintain the temperature of the extracted coconut water.

Further, the aseptic system includes a post-filtration unit for further filtering or separating impurities from the cold pre-filtered coconut water. The post-filtration unit consists of a second micro-filter for filtering the cold pre-filtered coconut water to produce post-filtered coconut water. In a preferred embodiment of the present invention, the second micro-filter ranges from 0.5 to 1 micron filters. Further, the post-filtration unit includes an ultra-filtration filter for ultra-filtering the post-filtered coconut water to produce sterile coconut water. In a preferred embodiment of the present invention, the ultra-filtration filter ranges from 0.01 to 0.02-micron filters.

Further, the aseptic system includes a cooling unit for cooling ultra-filtered coconut water at 4 degrees Celsius to produce cold ultra-filtered coconut water. Further, the aseptic system consists of an aseptic packaging unit for packaging the ultra-filtered coconut water in a sterile container within the specified period. In a preferred embodiment of the present invention, the specific period is 1 hour for extracting and packaging the coconut water.

The resulting coconut water is rendered sterile and retains its flavor, freshness, aroma, and nutritional components for 90 days when stored in refrigerated temperatures ranging from 35° F. to 40° F.

A primary object of the present invention is to provide a comprehensive system for aseptic and sterile packaging of fresh coconut water to preserve the freshness and flavor of natural raw coconut water.

An object of the present invention is to provide a comprehensive system and method for packaging sterile coconut water while safeguarding the nutritional content and preserving the natural raw characteristics of coconut water.

Another object of the present invention is to provide a groundbreaking approach of extracting and preserving an unparalleled coconut water product that faithfully captures the essence of natural, fresh, and raw coconut water characterized by a 100% cold process.

Yet another object of the present invention is to provide a system using a cold process for producing coconut water that is rendered sterile and retains its flavor, freshness, aroma, and nutritional components for 90 days when stored in refrigerated temperatures ranging from 35° F. to 40° F.

In one embodiment of the present invention, a method for extracting and packaging coconut water within a specific period is disclosed. The method comprises a step of extracting natural raw coconut water from one or more coconuts to collect extracted coconut water. The natural raw coconut water is extracted using a piercing needle from each of one or more coconuts to collect the extracted coconut water in a transparent glass vacuum jar.

Further, the method includes pre-filtering the extracted coconut water to produce pre-filtered coconut water. The extracted coconut water is filtered through a 20-micron filter to separate impurities like husks. Further, the method includes a step of cooling the pre-filtered water at 4 degrees Celsius to produce cold pre-filtered coconut water. The pre-filtered coconut water is kept in a collection tank maintained at 4 degrees Celsius.

Further, the method includes a step of post-filtering the cold pre-filtered coconut water to produce a post-filtered coconut water. The cold pre-filtered coconut water is filtered through a filter ranging from 0.05 to 0.1 microns. Further, the method includes a step of ultra-filtering the post-filtered coconut water to produce ultra-filtered sterile coconut water.

Further, the method includes a step of subsequently cooling the ultra-filtered coconut water at 4 degrees Celsius to produce a cold ultra-filtered coconut water. Further, the method includes a step of packaging the ultra-filtered coconut water in at least one sterile container to package the coconut water within the specified period. In a preferred embodiment of the present invention, the entire process, from the extraction of the coconut water to packaging of the coconut water in at least one sterile container, is completed within an hour.

Other objectives and aspects of the invention will become apparent from the following detailed description, taken in conjunction with the accompanying drawings, which illustrate, by way of example, the features in accordance with embodiments of the invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

Although, the invention is described above in terms of various exemplary embodiments and implementations, it should be understood that the various features, aspects, and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

The presence of broadening words and phrases such as “one or more,” “at least,” “but not limited to” or other like phrases in some instances shall not be read to mean that the narrower case is intended or required in instances where such broadening phrases may be absent.

### BRIEF DESCRIPTION OF THE DRAWINGS

The accompanying drawings illustrate various embodiments of systems, methods, and embodiments of various other aspects of the disclosure. It may be that in some examples one element may be designed as multiple elements or that multiple elements may be designed as one element. In some examples, an element shown as an internal component of one element may be implemented as an external component in another and vice versa. Furthermore, elements may not be drawn to scale. Non-limiting and non-exhaustive descriptions are described with reference to the following drawings. The components in the figures are not necessarily to scale, emphasis instead being placed upon illustrating principles. Furthermore, the drawings may contain text or captions that may explain certain embodiments of the present invention. This text is included for illustrative, non-limiting, explanatory purposes of certain embodiments detailed in the present invention. In the drawings:

Embodiments of the invention are described with reference to the following figures. The same numbers are used throughout the figures to reference like features and components. The features depicted in the figures are not necessarily shown to scale. Certain features of the embodiments may be shown exaggerated in scale or in somewhat schematic form, and some details of elements may not be shown in the interest of clarity and conciseness.

FIG. 1A illustrates an aseptic method for extracting coconut water in accordance with the present invention;

FIG. 1B illustrates an aseptic method for extracting and packaging coconut water in accordance with the present invention and

FIG. 2 illustrates a perspective view of an aseptic system for extracting and packaging coconut water in accordance with the present invention.

### DETAILED DESCRIPTION OF THE INVENTION

The present specification is directed towards multiple embodiments. The following disclosure is provided in order to enable a person having ordinary skill in the art to practice the invention. Language used in this specification should not be interpreted as a general disavowal of any one specific embodiment or used to limit the claims beyond the meaning of the terms used therein. The general principles defined herein may be applied to other embodiments and applications without departing from the spirit and scope of the invention. Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

In the description and claims of the application, each of the words “units” represents the dimension in any units such as centimeters, meters, inches, foots, millimeters, micrometer and the like and forms thereof, are not necessarily limited to members in a list with which the words may be associated.

In the description and claims of the application, each of the words “comprise”, “include”, “have”, “contain”, and forms thereof, are not necessarily limited to members in a list with which the words may be associated. Thus, they are intended to be equivalent in meaning and be open-ended in that an item or items following any one of these words is not meant to be an exhaustive listing of such item or items, or meant to be limited to only the listed item or items. It should be noted herein that any feature or component described in association with a specific embodiment may be used and implemented with any other embodiment unless clearly indicated otherwise.

Regarding applicability of 35 U.S.C. § 112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items from the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present invention contains headers. It should be understood that these headers are used as references and are not to be construed as limiting upon the subjected matter disclosed under the header.

This specification includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

The presence of broadening words and phrases such as “one or more,” “at least,” “but not limited to” or other like phrases in some instances shall not be read to mean that the narrower case is intended or required in instances where such broadening phrases may be absent.

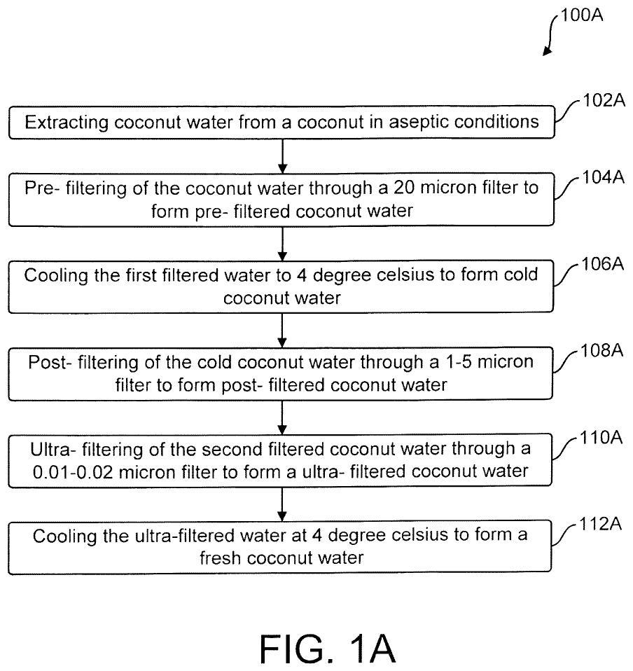

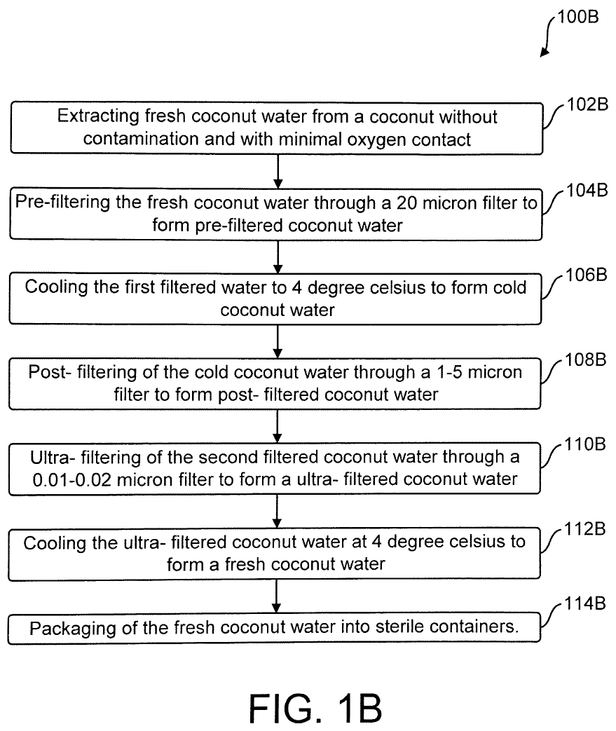

FIG. 1A illustrates an aseptic method for extracting coconut water. The method (100A) includes the step of extracting coconut water from a coconut without contamination and with minimal oxygen contact (102A). Then the coconut water is pre-filtered through a 20 micron filter to form pre-filtered coconut water (104A). Next, the pre-filtered coconut water is cooled to 4 degrees Celsius to form cold coconut water (106A).

Followed by this step, the cold coconut water is post-filtered through a 1-5 micron filter to form post-filtered coconut water (108A). Further, the post-filtered coconut water is ultra-filtered through a 0.01-0.02 micron filter to form a ultra-filtered coconut water (110A). Finally, the ultra-filtered water is cooled at 4 degrees Celsius to form fresh sterile coconut water (112A).

FIG. 1B illustrates an aseptic method (100B) for extracting and packaging a coconut water within a specific time period is disclosed. The method comprising a step (102B) of extracting a natural raw coconut water from one or more coconuts to collect an extracted coconut water. The natural raw water is extracted using a piercing needle from each of the one or more coconuts to collect the extracted coconut water. The extracted coconut water is collected in a transparent glass vacuum jar. The sanitized piercing needle pierces the coconut, extracting the water into a transparent vacuum glass jar. The method allows for visible inspection of the coconut water for purity, enabling the discarding of any spoiled portions in the coconut water.

Further, the method includes a step (104B) of pre-filtering the extracted coconut water to produce a pre-filtered coconut water. The extracted coconut water is filtered through a 20-micron filter for separating impurities like husk and alike impurities. Further, the method includes a step (106B) of cooling the pre-filtered water at 4 degree Celsius to produce a cold pre-filtered coconut water.

Further, the method includes a step (108B) of post-filtering the cold pre-filtered coconut water to produce a post-filtered coconut water. The cold pre-filtered coconut water is filtered through a filter ranging from 0.05 to 0.1 microns. Further, the method includes a step (110B) of ultrafiltering the post-filtered coconut water to produce an ultra-filtered sterile coconut water.

The post-filtered coconut water is further filtered to separate out impurities. The pre-filtered water is cooled down in a sterile pipe maintained at 4 degrees Celsius. Chilled coconut water then undergoes pre-filtration through two macro filters, initially through a 5-micron filter followed by a 1-micron filter.

Further, the method includes a step (112B) of subsequently cooling the ultra-filtered coconut water at 4 degrees Celsius to produce a cold ultra-filtered coconut water through a 0.02-0.01-micron filter. Further, the method includes a step (114B) of packaging the ultra-filtered coconut water in at least one sterile container to package the coconut water within the specified time period. In a preferred embodiment of the present invention, the entire process, from the extraction of the coconut water to packaging of the coconut water in at least one sterile container, is completed within an hour.

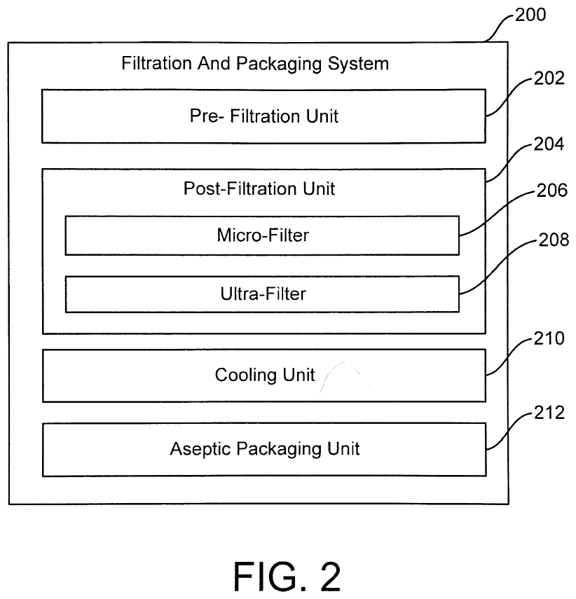

FIG. 2 illustrates a perspective view of an aseptic system (200) for packaging sterile coconut water while safeguarding its freshness, flavor, aroma, and nutritional content, preserving the natural raw characteristics of coconut water. The aseptic system (200) includes a thorough cleaning process of the coconuts followed by sanitation using a sanitizing agent. In preferred embodiment of the present invention, the sanitizing agent is per-acetic acid.

The aseptic system (200) includes an aseptic coconut water extraction unit (202) for extracting natural raw coconut water from one or more coconuts to collect extracted coconut water.

In a preferred embodiment of the present invention, the aseptic coconut water extraction unit (202) is a transparent vacuum glass jar for allowing visible purity checks and separating impurities from the natural raw coconut water. The natural raw coconut water is extracted with minimal oxygen contact using a piercing needle and collected in the aseptic coconut water extraction unit (202), ensuring minimal oxygen contact and contamination.

Further, the aseptic system (200) includes a pre-filtration unit (204) for filtering the extracted coconut water through a first micro-filter to produce pre-filtered coconut water. In a preferred embodiment of the present invention, the first micro-filter is a 20-micron filter to remove husks, fibers, and shells of one or more coconuts. Further, the aseptic system (200) includes an aseptic piping unit for cooling the pre-filtered coconut water at 4 degrees Celsius to produce a cold pre-filtered coconut water. In a preferred embodiment of the present invention, the aseptic piping unit is a sterile pipe maintained at 4 degrees Celsius for cooling and maintaining the temperature of the extracted coconut water.

Further, the aseptic system (200) includes a post-filtration unit (206) for further filtering or separation of impurities from the cold pre-filtered coconut water. The post-filtration unit (206) includes a second micro-filter for filtering the cold pre-filtered coconut water to produce a post-filtered coconut water. In preferred embodiment of the present invention, the second micro-filter (208) is a filter ranging from 0.5 to 1-micron filters. Further, the post-filtration unit includes an ultra-filter (210) for ultra-filtering the post-filtered coconut water to produces an ultra-filtered coconut water. In preferred embodiment of the present invention, the ultra-filtration filter is a filter ranging from 0.01 to 0.02-micron filters.

Further, the aseptic system (200) includes a cooling unit (212) for subsequently cooling the ultra-filtered coconut water at 4 degrees Celsius to produce a cold ultra-filtered coconut water.

Furthermore, the aseptic system (100) includes an aseptic packaging unit (214) for packaging the ultra-filtered coconut water in at least one sterile container within the specified time period.

In preferred embodiment of the present invention, the specific time period is 1 hour for extracting and packaging the coconut water. The resulting coconut water is rendered sterile and retains its flavor, freshness, aroma, and nutritional components for a duration of 90 days when stored in refrigerated temperatures ranging from 35-degrees F. to 40-degrees F.

End Product Evaluation and Lab Results: Comprehensive testing of the resulting product revealed no degradation in freshness, flavor, or aroma of coconut water. Coconut water exhibited a fresh taste akin to drinking directly from a coconut. In a series of 3 separate runs involving 1000 bottles of 10.14 oz, no change in flavor was observed, preserving the freshness of natural raw coconut water. Random lab tests indicated a 5-log reduction of pathogens from raw coconut to sterile packaged coconut water. Shelf-life tests demonstrated that packaged coconut water exhibited no degradation or alteration in freshness, flavor, or aroma even after 90 days in refrigerated conditions.

While illustrative implementations of the application have been described in detail herein, it is to be understood that the inventive concepts may be otherwise variously embodied and employed, and that the appended claims are intended to be construed to include such variations, except as limited by the prior art.

Reference throughout this specification to “one implementation” or “an implementation” means that a particular feature, structure, or characteristic described in connection with the implementation is included in at least one implementation of the present invention. Thus, the appearances of the phrases “in one implementation” or “in some implementations” in various places throughout this specification are not necessarily all referring to the same implementation. Furthermore, the particular features, structures, or characteristics may be combined in any suitable manner in one or more implementations.

Systems and methods describing the present invention have been described. It will be understood that the descriptions of some embodiments of the present invention do not limit the various alternative, modified, and equivalent embodiments which may be include within the spirit and scope of the present invention as defined by the appended claims. Furthermore, in the detailed description above, numerous specific details are set forth to provide an understanding of various embodiments of the present invention. However, some embodiments of the present invention may be practiced without these specific details. In other instances, well known methods, procedures, and components have not been described in detail so as not to unnecessarily obscure aspects of the present embodiments.

1. A method for extracting fresh coconut water within a specific time-frame, wherein the method comprises:
extracting coconut water from a coconut without contamination and with minimal oxygen contact;
pre-filtering of the coconut water through a 20-micron filter to form pre-filtered coconut water;
cooling the first filtered water to 4 degrees celsius to form cold coconut water;
post-filtering of the cold coconut water through a 1-5 micron filter to form post-filtered coconut water;
ultra-filtering of the post-filtered coconut water through a 0.01-0.02 micron filter to form an ultra-filtered coconut water, and
cooling the ultra-filtered water to 4 degrees Celsius to form fresh coconut water.

2. The method in accordance with claim 1, wherein the coconut water is extracted via a piercing needle and collected into a transparent glass vacuum jar to form collected water.

3. The method in accordance with claim 2, wherein the transparent glass vacuum jar provides a visible check to discard the spoiled coconut water.

4. The method in accordance with claim 1, wherein the collected water is passed through a 20-micron filter to remove coconut husk, fiber, or shell present.

5. The method is in accordance with claim 1, wherein the method preserves freshness, flavor, aroma, and nutritional content of the coconut water.

6. The method in accordance with claim 1, wherein the fresh coconut water is aseptically packaged into sterile containers.

7. A method for extraction and packaging fresh coconut water within a specific timeframe, wherein the method comprises:
extracting fresh coconut water from a coconut;
pre-filtering the fresh coconut water through a 20-micron filter to form pre-filtered coconut water;
cooling the first filtered water to 4 degrees celsius to form cold coconut water;
post-filtering of the cold coconut water through a 1-5 micron filter to form post-filtered coconut water;
ultra-filtering of the post-filtered coconut water through a 0.01-0.02 micron filter to form an ultra-filtered coconut water;
cooling the ultra-filtered coconut water at 4 degrees Celsius to form fresh coconut water and packaging of the fresh coconut water into sterile containers.

8. The method in accordance with claim 7, wherein the extraction of coconut water from coconut is performed without contamination and with minimal oxygen contact.

9. The method in accordance with claim 8, wherein the coconut water is extracted via a piercing needle and collected into a transparent glass vacuum jar to form collected water.

10. The method in accordance with claim 7, wherein whole process of filtering and packaging takes about an hour to complete.

11. An aseptic system for extracting and packaging coconut water within a specific time period, wherein the aseptic system comprises:
an aseptic coconut water extraction unit for extracting natural raw coconut water from one or more coconuts to collect extracted coconut water;
a filtration unit, wherein the filtration unit includes;
a pre-filtration unit for filtering the extracted coconut water through a first micro-filter to produce pre-filtered coconut water, further wherein an aseptic piping unit for cooling the pre-filtered coconut water at 4 degrees Celsius to produce cold pre-filtered coconut water;
a post-filtration unit, wherein the post-filtration unit includes:
a second micro-filter for filtering the cold pre-filtered coconut water to produce post-filtered coconut water; and
an ultra-filtration filter for ultra-filtering the post-filtered coconut water to produces an ultra-filtered coconut water;
a cooling unit for subsequently cooling the ultra-filtered coconut water at 4 degrees Celsius to produce a cold ultra-filtered coconut water; and
an aseptic packaging unit for packaging the ultra-filtered coconut water in at least one sterile container within the specified time period.

12. The aseptic system in accordance with claim 1, wherein the first micro-filter is a 20-micron filter to remove husks, fibers, and shells of one or more coconuts.

13. The aseptic system in accordance with claim 1, wherein the second micro-filter is a filter ranging from 0.5 to 1-micron filters.

14. The aseptic system in accordance with claim 1, wherein the ultra-filtration filter is a filter ranging from 0.01 to 0.02-micron filters.

15. The aseptic system in accordance with claim 1, wherein the specific time period is 1 hour for extracting and packaging the coconut water.
